(19) United States
(12) Patent Application Publication
(10) Pub. No.: US 2005/0258086 A1
(43) Pub. Date: Nov. 24, 2005

(54) Aquarium filter having check valve

(76) Inventor: Chi-Hung Lin, Taichung Hsien (TW)

Correspondence Address: LAW OFFICE OF LIAUH & ASSOC., 4224 WAIALAE AVE, STE 5-388, HONOLULU, HI, 96816, US

(21) Appl. No.: 10/850,250

(22) Filed: May 18, 2004

(51) Int. Cl. A01K 63/04

(52) U.S. Cl. 210/169; 210/416.2; 119/259

(57) ABSTRACT

An external aquarium filter comprises an intake chamber for receiving contaminated water from an aquarium tank, a filtering chamber in flow communication with the intake chamber for filtering the contaminated water to return clean water back to the aquarium tank, a partition wall between the intake and filtering chambers for overflowing water from the intake chamber into the filtering chamber, an intake tube for supplying water the intake chamber, the intake tube including a check valve therein, and a pump for drawing water from the aquarium filter into the intake chamber through the intake tube. Responsive to stopping the pump, unfiltered water in the intake chamber is prevented from flowing back into the aquarium tank through the check valve. Also, water in the intake chamber is stored as priming water for a future restarting of the aquarium filter.

### BACKGROUND OF THE INVENTION

1. Field of the Invention

The present invention relates to aquarium filters and more particularly to an external aquarium filter having a check valve so as to prevent solid particles, impurities, etc. in an inoperative filter from flowing back to an aquarium tank due to a siphoning action.

2. Description of Related Art

Referring to FIG. 1A, it shows the normal flow of aquarium water through a conventional filter. In detail, the filter housing 10 comprises an intake chamber 13 and a filtering chamber 12 which are separated by a partition wall 11. A pump 14 is provided under the intake chamber 13. An impeller 15 is disposed in the intake chamber 13 and is rotatably coupled to the pump 14. A bent intake tube 16 has one end positioned in an aquarium tank (not shown) and the other end proximate the impeller 15. Upon energizing the pump 14 and thus the impeller 15, water from the aquarium tank is sucked into the intake tube 16. The water then flows up through the intake tube 16 and is drawn into the intake chamber 13. The water filled in the intake chamber 13 will overflow the partition wall 11 into the filtering chamber 12 if it has a sufficient height. The filtration material provided in the filtering chamber 12 is used to filter the water. The filtered water is then passed back into the aquarium tank through a spillway (not shown).

Referring to FIG. 1B, it is assumed that power outage has occurred or the impeller 15 failed to operate normally due to a piece of debris getting stuck therein. When such stoppage occurs, water in the intake chamber 13 begins to reverse flow out of the intake chamber 13 due to a siphoning action since the filter is provided at a level higher than the external aquarium tank. At the same time, water in the filtering chamber 12 flows backward over the partition wall 11 for filling the intake chamber 13.

Referring to FIG. 1C, water in the intake chamber 13 is completely drained after water has gradually flowed back into the aquarium tank through the intake tube 16 and the water level of the filtering chamber 12 is no more higher than that of the intake chamber 13. If the power to the pump 14 resumes, the filter will not begin but will remain in the stage shown in FIG. 1C. In order for the filter to begin, it must be primed whereby sufficient water is placed in the intake chamber 13 to cover the impeller 15 so that the impeller 15 will be able to spread water out and cause a reduced pressure thereby sucking in additional water. In the absence of such priming water, the filter will not restart and will remain in the state shown in FIG. 1C. However, since the electricity will begin flowing to the pump 14, the pump 14 will heat up. Since there is no circulating water in the pump 34, the pump 34 will continue to generate heat. This heat may cause damage to the intake chamber 13. Moreover, the failure of the filter to provide adequate filtration to the aquarium tank may cause damage and harm to the contents of the aquarium itself.

In U.S. Pat. No. 4,761,227 there is disclosed a self priming aquarium filter for overcoming the above drawback as illustrated in FIGS. 2A and 2B. A narrow passageway 17 is provided in the partition wall 11. The cross-sectional area of the passageway 17 is less than that of the intake tube 16. Accordingly, after the majority of water has flowed over the partition wall 11 (see FIG. 1B), and when water level of the filtering chamber 12 has reached the upper end of the partition wall 11 (see FIG. 1C), a small trickle flow will still flow through the passageway 17 from the filtering chamber 12 back into the intake chamber 13. But the siphoning action of the intake tube 16 with respect to the intake chamber 13 will operate faster than the trickle flow. Hence, the siphoning flow will cause the water to drain out of the intake chamber 13 faster than the trickle flow flows into the intake chamber 13. As an end, the water will deplete from the intake chamber 13 beneath the level of the impeller 15. Thereafter, the siphon breaks and no more water will flow outwardly from the intake chamber 13. When this occurs, the continuous trickle flow passing through the passageway 17 will now begin accumulating in the intake chamber 13. As a result, the intake chamber 13 is filled with sufficient priming water. Upon resumption of power, the filter and thus the impeller 15 will automatically start a normal operation without adding priming water manually. The patent aids in permitting the siphoning action to break prior to providing a sufficient trickle flow to reprime the filter.

However, the patent still suffered from a disadvantage. For example, a small portion of unfiltered water in the filtering chamber 12 due to power outage may flow back into the aquarium tank through the passageway 17, the intake chamber 13, and the intake tube 16 due to the siphoning action. This may cause damage and harm to the contents of the aquarium itself. Thus, the need for improvement still exists.

### SUMMARY OF THE INVENTION

It is an object of the present invention to provide an aquarium filter for mounting externally of an aquarium tank, comprising an intake chamber for receiving contaminated water from the aquarium tank; a filtering chamber in flow communication with the intake chamber, the filtering chamber including a filtration member for filtering the contaminated water to return clean water back to the aquarium tank; a partition wall disposed between the intake chamber and the filtering chamber for overflowing water from the intake chamber into the filtering chamber; an intake tube for supplying water from the aquarium tank to the intake chamber, the intake tube including a check valve in a first predetermined position; and pump means having an impeller for drawing water from the aquarium filter into the intake chamber through the intake tube; wherein responsive to stopping the pump means, unfiltered water in the intake chamber is prevented from flowing back into the aquarium tank through the check valve, and water in the intake chamber is stored as priming water for a future restarting of the aquarium filter.

The above and other objects, features and advantages of the present invention will become apparent from the following detailed description taken with the accompanying drawings.

### BRIEF DESCRIPTION OF THE DRAWINGS

FIG. 1A shows the normal flow of the aquarium water through the well known filter;

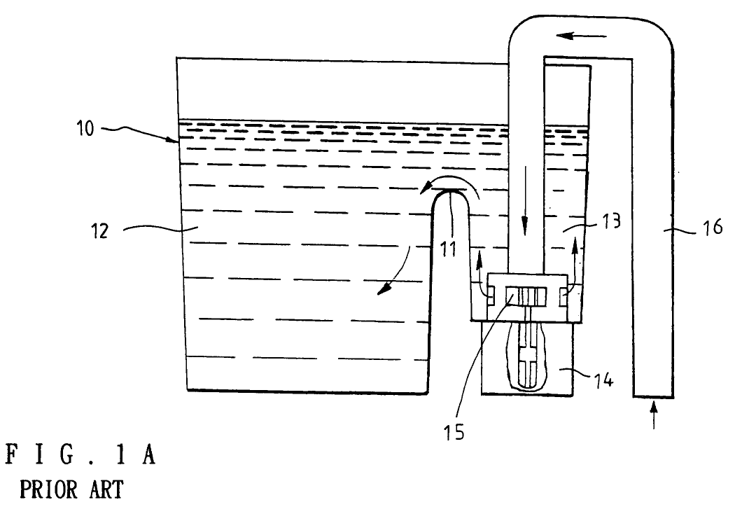

FIG. 1B shows a reversal of water flow due to a siphoning action when power to the pump is stopped so that the pump is no longer operating;

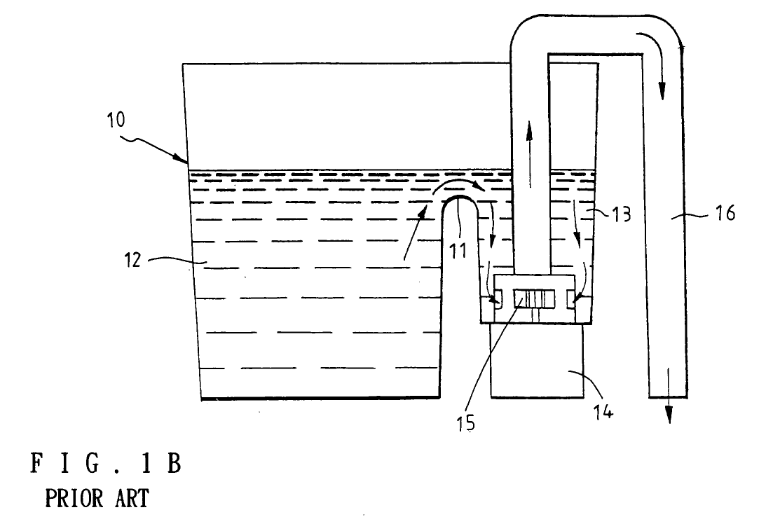

FIG. 1C shows draining of the intake chamber that occurs with the well known filter due to the siphoning action;

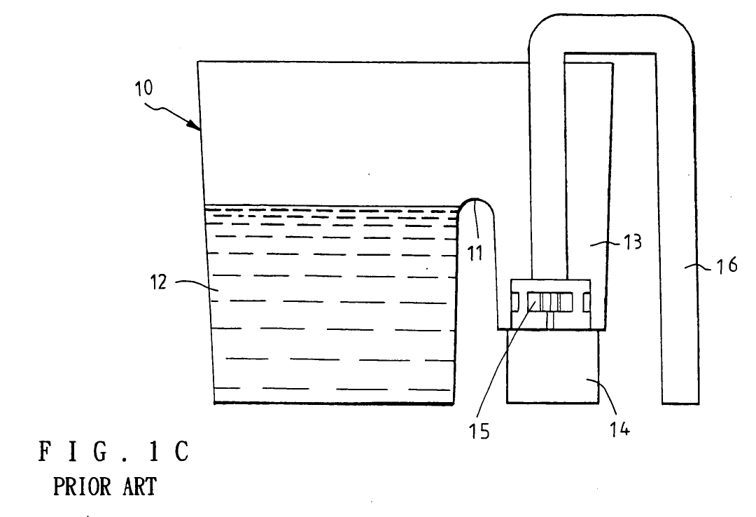

FIG. 2A shows the presence of the passageway in the partition wall which permits a continued trickle flow back from the filtering chamber to the intake chamber;

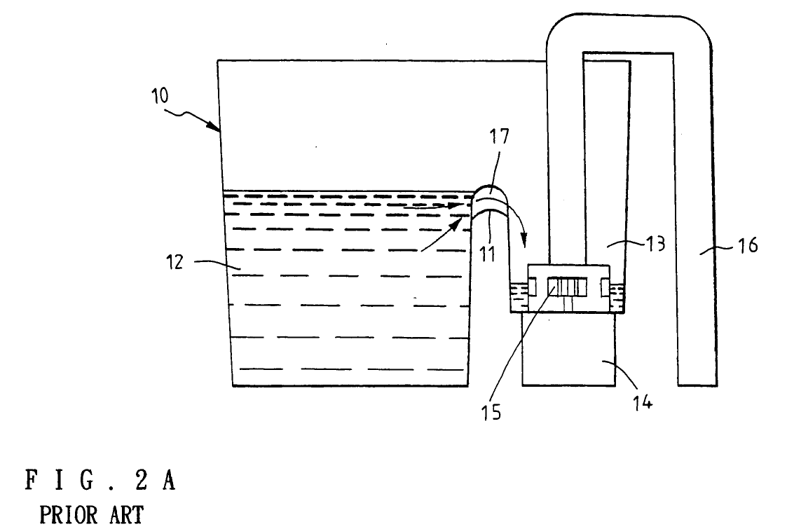

FIG. 2B shows the resultant water retained in the intake chamber for self-priming of the filter for restarting of the filter operation;

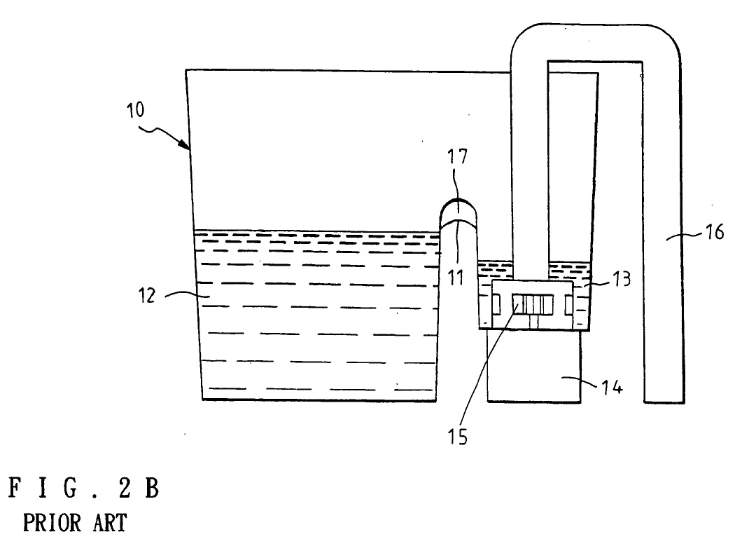

FIG. 3 is an exploded view of an external aquarium filter according to the invention;

FIG. 4 is a perspective view of the assembled filter of FIG. 3 with the cover removed;

FIG. 5 is a cross-sectional view for showing the normal flow of the aquarium water into the intake chamber through the intake tube; and

FIG. 6 is a view similar to FIG. 5 for showing the complete blockage of a reversal of water flow through the intake tube.

### DETAILED DESCRIPTION OF THE PREFERRED EMBODIMENTS

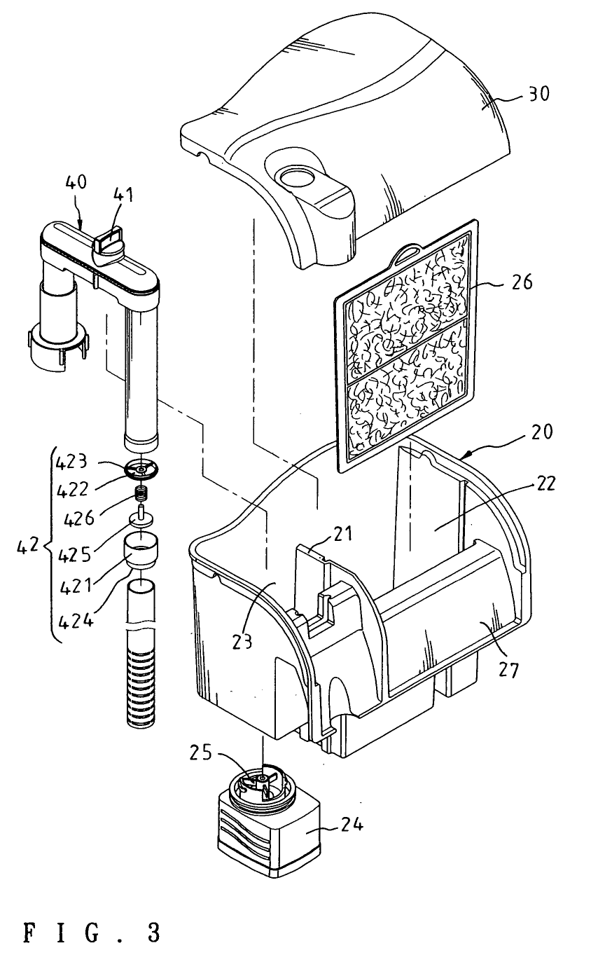

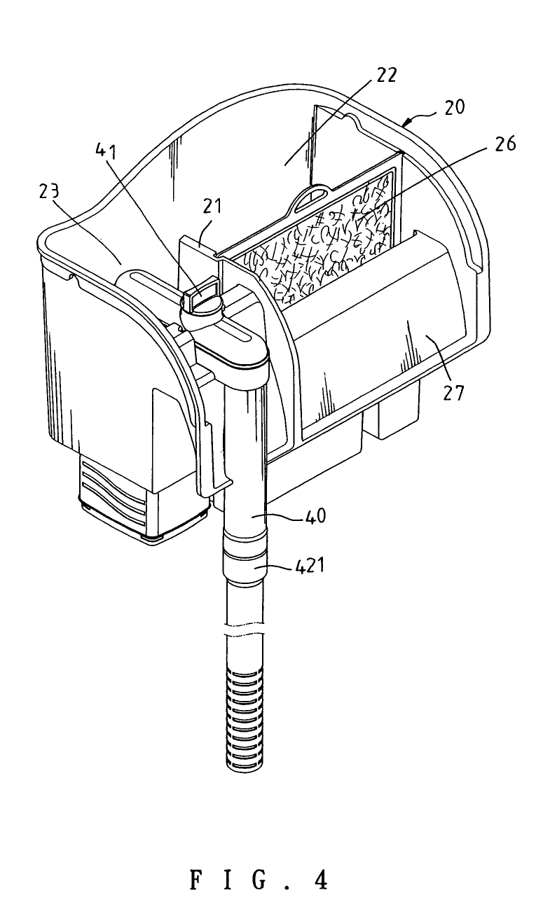

Referring to FIGS. 3 and 4, there is shown an external aquarium filter constructed in accordance with the invention. The filter comprises a filter housing 20 having an internal space divided into an intake chamber 23 and a filtering chamber 22 by a partition wall 21. A removable cover 30 snugly fits onto a peripheral lip on a top of the filter housing 20. A pump 24 is provided under the intake chamber 23. An impeller 25 is disposed in the intake chamber 23 and is rotatably coupled to the pump 24. A filter panel 26 is vertically mounted in the filtering chamber 22. A spillway 27 is extended obliquely downwardly from a top edge of the filtering chamber 22. An L-shaped intake tube 40 is held on a top notch of the frame of the intake chamber 23 and has one end positioned in an aquarium tank (not shown) and the other end proximate the impeller 25. A flow-control valve 41 is provided in a horizontal section of the intake tube 40. Moreover, a check valve 42 is provided in a vertical portion of the intake tube 40 under the bottom of the filter housing 20. The check valve 42 comprises an enlargement 421, a disk member 23 having a plurality of apertures 422, an inlet 424 in the bottom of the enlargement 421 coupled to the intake tube 40, a poppet 425 having a post inserted into the central aperture 422 for positioning, and a spring 426 put on the post and compressed between the disk member 23 and the disk portion of the poppet 425. In an inoperative state of the filter, the inlet 424 is completely blocked by the poppet 425 due to the expansion of the spring 426.

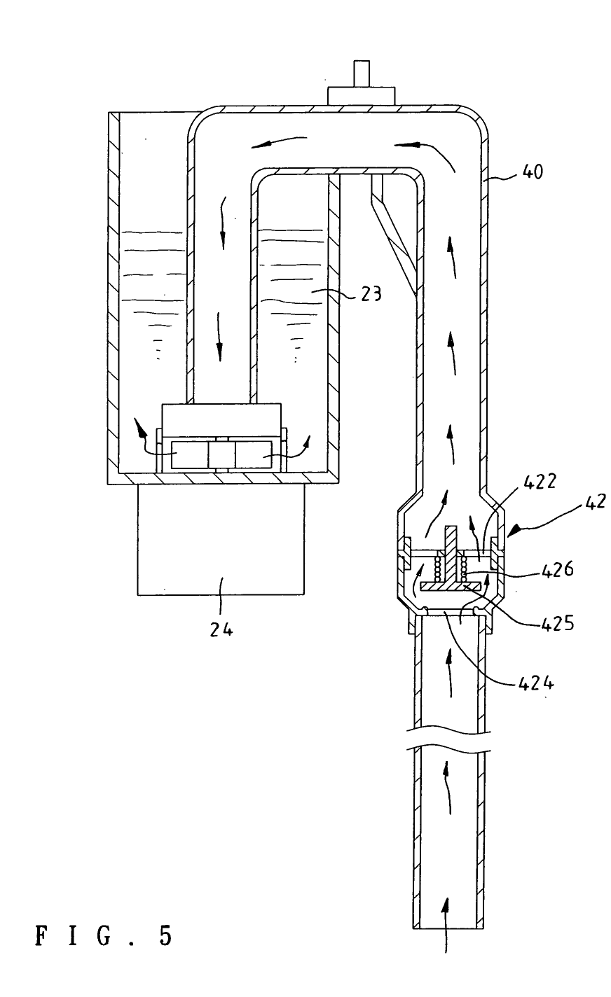

Referring to FIG. 5, upon energizing the pump 24, water will be drawn from the aquarium tank into the intake chamber 23 through the intake tube 40 in which the inlet 424 is open by compressing the spring 426 by the pressure of the water in the intake tube 40, and water then flows through the inlet 424 and the apertures 422. The filter in the intake chamber 23 will overflow the partition wall 21 into the filtering chamber 22 if it has a sufficient height. The filtration material of the filter panel 26 is used to filter the water. The filtered water is then passed back into the aquarium tank through the spillway 27.

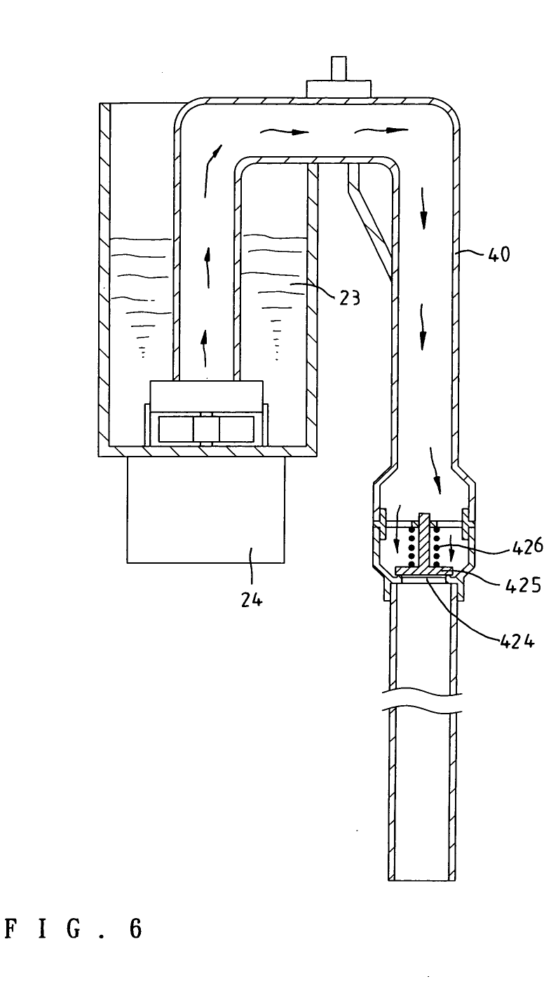

Referring to FIG. 6, if the pump 24 stops due to power outage, water in the intake chamber 23 begins to reverse flow out of the intake chamber 23 due to a siphoning action. However, the flow is completely blocked by the check valve 42. In detail, the spring 426 expands immediately to push the poppet 425 to close the inlet 424 in response to the inoperative pump 24 as a result of stored elastic force therein. The unfiltered water in the filtering chamber 22 is thus prevented from flowing back into the aquarium tank through the intake chamber 23 and the intake tube 40 due to the siphoning action. This can protect the contents of the aquarium itself and store sufficient priming water in the intake chamber 23. Therefore, if the power to the pump 24 resumes, the filter will automatically begin to operate normally without adding priming water manually.

While the invention herein disclosed has been described by means of specific embodiments, numerous modifications and variations could be made thereto by those skilled in the art without departing from the scope and spirit of the invention set forth in the claims.

1. An aquarium filter for mounting externally of an aquarium tank, comprising:
an intake chamber for receiving contaminated water from the aquarium tank;
a filtering chamber in flow communication with the intake chamber, the filtering chamber including a filtration member for filtering the contaminated water to return clean water back to the aquarium tank;
a partition wall disposed between the intake chamber and the filtering chamber for overflowing water from the intake chamber into the filtering chamber;
an intake tube for supplying water from the aquarium tank to the intake chamber, the intake tube including a check valve in a first predetermined position; and
pump means having an impeller for drawing water from the aquarium filter into the intake chamber through the intake tube;
wherein responsive to stopping the pump means, unfiltered water in the intake chamber is prevented from flowing back into the aquarium tank through the check valve, and water in the intake chamber is stored as priming water for a future restarting of the aquarium filter.

2. The aquarium filter of claim 1, wherein the check valve is housed in an enlargement of the intake tube and comprises a disk member having a plurality of apertures, an inlet in a bottom of the enlargement coupled to the intake tube, a poppet having a post inserted into one of the apertures for positioning, and a spring put on the post and compressed between the disk member and the poppet so that in an inoperative state of the aquarium filter, the inlet is completely blocked by the poppet due to an expansion of the spring, and the inlet is completely open due to a compression of the spring by water pressure in the intake tube.

3. The aquarium filter of claim 1, further comprising a removable cover snugly fitted onto a top of the aquarium filter.

4. The aquarium filter of claim 1, further comprising a flow-control valve in a second predetermined position of the intake tube.
